(19) United States
(12) Patent Application Publication
(10) Pub. No.: US 2026/0326241 A1
(43) Pub. Date: Oct. 22, 2026

(54) METHOD AND APPARATUS FOR COOPERATIVELY PREPARING MULTI-LEVEL HETEROSTRUCTURE OF WELD SEAM BY USING DUAL LASER BEAMS

(71) Applicant: SOOCHOW UNIVERSITY, Suzhou (CN)

(72) Inventors: Shuncun LUO, Suzhou (CN); Zhikang WU, Suzhou (CN); Zengrong HU, Suzhou (CN); Mingrui CHEN, Suzhou (CN); Xiaonan WANG, Suzhou (CN); Hiromi NAGAUMI, Suzhou (CN)

(73) Assignee: SOOCHOW UNIVERSITY, Suzhou (CN)

(21) Appl. No.: 19/694,371

(22) Filed: Jun. 1, 2026

Related U.S. Application Data
(63) Continuation of application No. PCT/CN2025/076427, filed on Feb. 8, 2025.

(30) Foreign Application Priority Data
Feb. 28, 2024 (CN) 202410223447.9

(51) Int. Cl. B23K 26/348; B23K 26/06; B23K 26/082; B23K 35/02; B23K 35/28; B23K 103/10

(52) U.S. Cl. CPC B23K 26/348; B23K 26/0608; B23K 26/082; B23K 35/0261; B23K 35/288; B23K 2103/10

(57) ABSTRACT

The present disclosure discloses a preparation apparatus including a fiber laser with a galvanometer system, a short-band laser, a dual-band hybrid oscillating welding head, an optical path system, a control system, a cooling system, and a protection device, and a preparation method including using a fiber laser to perform oscillating filler welding, wherein the weld seam filler material is Al—Si—Mg—Cu—Zn—Sn series alloys, and a weld seam having a heterogeneous grain structure is obtained; in addition, using a short-band laser to bake the weld seam online, to promote the composite precipitation of multiple nano-phases in a gradient distribution in the depth direction of the weld seam. With the apparatus and method, an aluminum alloy weld seam having a multi-level heterostructure can be prepared, the comprehensive performance of the welded joint is synergistically improved, thereby solving the problem of mismatch between strength and plasticity of a fusion weld seam.

### FIELD OF THE INVENTION

The present disclosure relates to the technical field of metal material welding, and in particular, to a method and apparatus for cooperatively preparing multi-level heterostructure of weld seam by using dual laser beams.

### DESCRIPTION OF THE RELATED ART

With the development of the industrial age, automobiles are becoming increasingly common in daily life, but this also brings high energy consumption and environmental pollution problems. Vehicle body lightweighting is considered an effective strategy to reduce automobile energy consumption and pollution. Therefore, aluminum alloys with low density and high strength have been widely used. However, under the action of a welding heat source, the softening problem of aluminum alloy weld seams severely deteriorates the mechanical properties of welded joints. To date, people have improved the mechanical properties of welded joints through traditional methods such as grain boundary strengthening, precipitate strengthening, solid solution strengthening, and deformation strengthening. Although these methods increase the strength and hardness of the weld seam, they sacrifice plasticity, leading to the problem of trade-off between strength and plasticity of the weld seam.

In recent years, it has been found that the mechanical properties of metal materials with a gradient heterostructure exceed expectations, and the synergistic effect of heterogeneous regions can simultaneously improve the strength and plasticity of the weld seam. Heterostructures exhibit significant material/structure differences between regions, usually in the form of macroscopic/microscopic structural heterogeneity. This heterostructure design is inspired by heterostructure biomaterials found in nature, which have evolved through millions of years of natural selection to survive in harsh environments. Heterostructures endow biomaterials with unprecedented performance and functional synergies.

Inspired by nature, researchers have used heterostructures as a new strategy to tailor the properties of aluminum alloys. Patent CN 116162872 A uses a process method of solution treatment—rapid heating large deformation—aging to prepare a multi-level heterogeneous strengthened structure, improving the mechanical properties such as hardness and strength of aluminum alloy. Patent CN 116479281 A prepares an alloy with a mixed-crystal heterostructure characteristic by adding TiB₂ and TiC particles during aluminum alloy preparation, followed by extrusion and solution heat treatment, thereby simultaneously improving the strength and elongation of aluminum alloy profiles. However, the existing methods are not suitable for preparing a heterostructure in a weld seam and cannot meet the welding manufacturing requirements of automobile bodies.

### SUMMARY OF THE INVENTION

The purpose of the present disclosure is to provide a method and apparatus for cooperatively preparing multi-level heterostructure of weld seam by using dual laser beams, aiming to simultaneously improve the strength and plasticity of the weld seam to meet the welding manufacturing requirements of automobile bodies. To achieve this purpose, the present disclosure adopts the following technical solutions:

A method for cooperatively preparing multi-level heterostructure of weld seam by using dual laser beams, including:
step (1): performing filler welding on an aluminum alloy sheet by using an oscillating laser, wherein solidified grains in a melt pool are repeatedly broken up into broken grains by means of the reheating effect of beam oscillation, to provide nucleation conditions for the formation of a fine equiaxed grain zone;
step (2): repeatedly scanning a weld seam obtained from oscillating laser welding by using a laser, to achieve rapid short-time baking of the weld seam, such that a temperature field generated by baking forms a gradient distribution in a depth direction of the weld seam;
step (3): adjusting process parameters of laser welding and laser baking, to cooperatively control solidification parameters of the melt pool and the temperature field of the weld seam, wherein broken dendrites are retained to form a fine equiaxed grain zone at a bottom of the melt pool, and temperature conditions for nano-phase precipitation are satisfied, to promote the precipitation of multiple nano-phases in a gradient distribution in the depth direction of the weld seam, such that the aluminum alloy weld seam comprises heterogeneous grain structure of a mixture of fine equiaxed grain zone and coarse grain region, and a gradient precipitate phase structure, to form a multi-level heterostructure.

Further, the aluminum alloy in step (1) is a heat-treatable strengthened aluminum alloy and is selected from the group consisting of 2XXX series, 4XXX series, 5XXX series, 6XXX series, 7XXX series aluminum alloys and any combination thereof.

Further, a reheating temperature caused by the power, oscillation frequency, and oscillation amplitude of the oscillating laser welding in step (1) is matched with a solidification range of the aluminum alloy sheet.

Further, the oscillating laser filler welding in step (1) is selected from the group consisting of oscillating laser wire-filling welding, oscillating laser powder-filling welding, oscillating laser sheet-filling welding, oscillating laser-CMT hybrid welding, oscillating laser-MIG hybrid welding, oscillating laser-TIG hybrid welding and any combination thereof.

Further, a filler material in step (1) is an Al—Si—Mg—Cu—Zn—Sn series alloy or an Al—Mg—Si—Cu—Zn—Sn series alloy.

Further, the form of the filler material is selected from the group consisting of powder of 10 to 200 μm, a thin sheet of 50 to 1000 μm, a welding wire with a diameter of 0.5 to 3.2 mm and any combination thereof.

Further, a laser for baking used in step (2) is selected from the group consisting of an infrared laser, a blue laser, a green laser and any combination thereof.

Further, the solidification parameters of the melt pool in step (3) comprise temperature gradient, solidification rate, and cooling rate.

Further, a temperature for the rapid short-time baking in step (2) is 100 to 350 °C, and a baking time is 0 to 30 min.

An apparatus for cooperatively preparing multi-level heterostructure of weld seam by using dual laser beams includes a fiber laser with a galvanometer system, a short-band laser, an optical path system, a dual-band hybrid oscillating welding head, a control system, a cooling system, and a protection device, wherein the fiber laser and the short-band laser are installed side by side on an upper portion of the optical path system, the dual-band hybrid oscillating welding head is installed on a lower portion of the optical path system, the control system is in communication connection with the optical path system, the cooling system is installed on the fiber laser and the short-band laser, the protection device is connected to the optical path system.

Further, the cooling system is a cooling water pipe, and the protection device is an inert gas protection pipe.

The beneficial effects of the invention are:
1. By cooperatively using oscillating laser welding and laser online baking of the weld seam, a multi-level heterostructure of heterogeneous grains structure and gradient precipitate phases is prepared, which significantly improves the strength and ductility of the weld seam, and solves the problem of an inverse relationship between strength and plasticity in fusion weld seams of heat-treatable strengthened aluminum alloys;
2. The characteristics of heterostructure are adjustable without enlarging the welding heat-affected zone;
3. Oscillating laser welding can effectively inhibit defects such as porosity formation, increase the supersaturation of the aluminum matrix, promote rapid precipitation of multiple strengthening phases during the laser baking process, and greatly improve welding quality and efficiency;
4. The method/apparatus is flexible and efficient, capable of realizing integrated and synchronized welding and baking for large structures, complex joints, and micro-areas, and supports online monitoring of the on-site welding process and baking temperature, to meet the welding manufacturing requirements of high-end equipment.

### BRIEF DESCRIPTION OF THE DRAWINGS

The drawings described herein are used to provide a further understanding of the present disclosure and form a part of the present disclosure. The exemplary embodiments and descriptions thereof in the present disclosure are used to explain the present disclosure and not to limit the present disclosure in any improper way.

FIG. 1 is a flowchart of a method for cooperatively preparing multi-level heterostructure of weld seam by using dual laser beams according to the present disclosure;

FIG. 2 is a schematic structural diagram of an apparatus for cooperatively preparing multi-level heterostructure of weld seam by using dual laser beams according to the present disclosure;

FIG. 3 is a longitudinal cross-sectional grain morphology diagram of Comparative Example 1 according to the present disclosure;

FIG. 4 is a longitudinal cross-sectional grain morphology diagram of Example 1 according to the present disclosure;

FIG. 5 is a cross-sectional microhardness diagram of Example 1, Example 2, and Comparative Example 1 according to the present disclosure;

FIG. 6 is a tensile mechanical property diagram of Example 1, Example 2, and Comparative Example 1 according to the present disclosure.

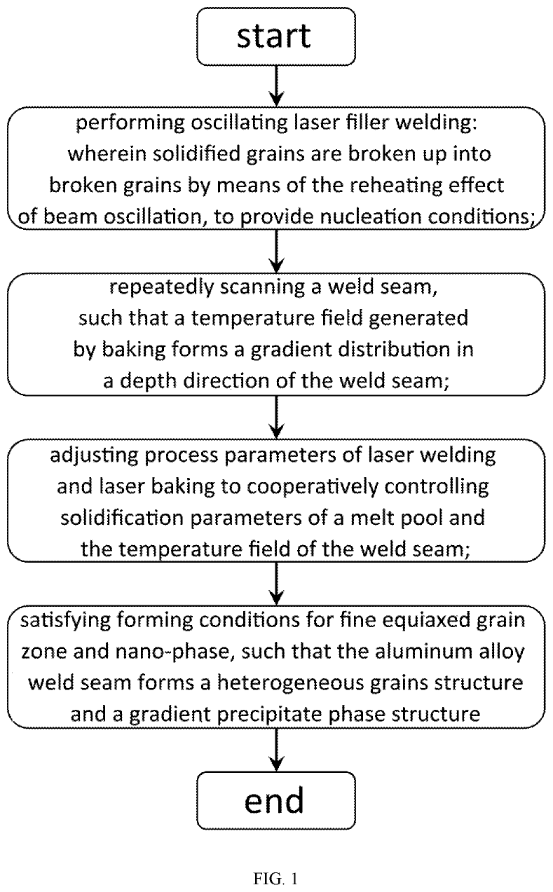

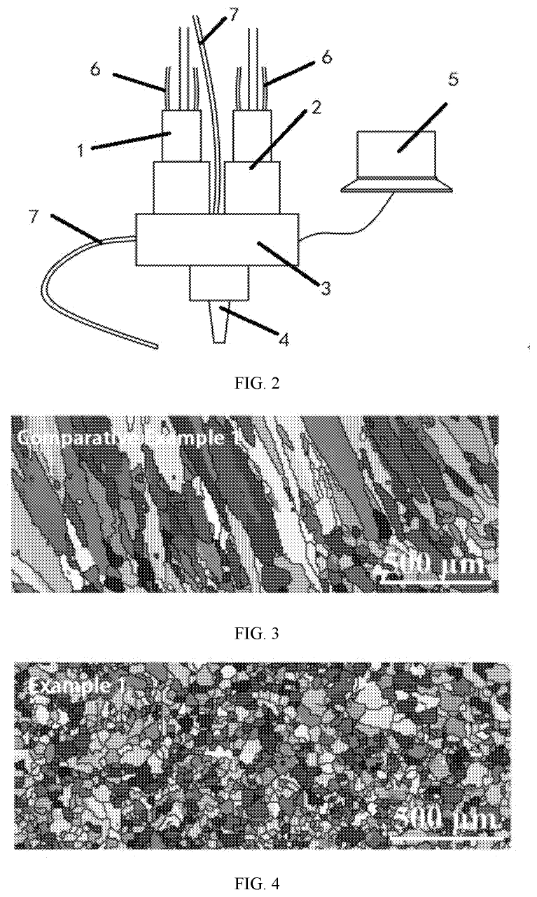

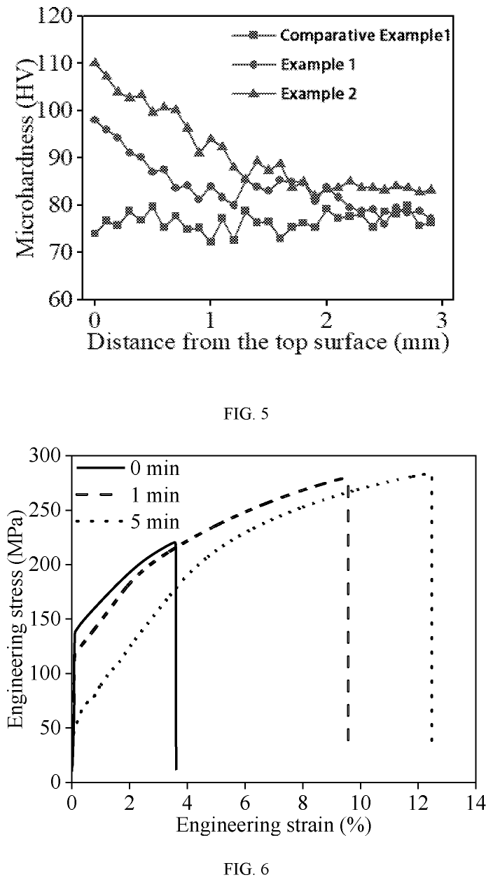

### DETAILED DESCRIPTION OF THE PREFERRED EMBODIMENTS

To make the technical problems solved, technical solutions adopted, and technical effects achieved by the present disclosure clearer, the technical solutions in the embodiments of the present disclosure will be further described in detail below. Apparently, the described embodiments are only part of the embodiments of the present disclosure, not all of the embodiments. Based on the embodiments in the present disclosure, all other embodiments obtained by those skilled in the art without contributing creative labor will belong to the protection scope of the present disclosure.

An apparatus for cooperatively preparing multi-level heterostructure of weld seam by using dual laser beams includes a fiber laser 1 with a galvanometer system, a short-band laser 2, an optical path system 3, a dual-band hybrid oscillating welding head 4, a control system 5, a cooling system 6, and a protection device 7. The fiber laser and the short-band laser are installed side by side on an upper portion of the optical path system. The dual-band hybrid oscillating welding head is installed on a lower portion of the optical path system. The control system is in communication connection with the optical path system. The cooling system is installed on the fiber laser and the short-band laser. The protection device is connected to the optical path system.

The cooling system is a cooling water pipe, the protection device is an inert gas protection pipe, and the control system is a computer.

Example 1: this example is a method for obtaining a multi-level heterostructure strengthening structure. The welding base material was a 3 mm thick Al—Mg—Si—Cu alloy sheet with dimensions of 50 mm by 50 mm. The filler material was an Al—Si—Mg—Cu—Zn aluminum alloy welding wire with a diameter of 1.2 mm.

The specific implementation steps of this example were:
(1) Oscillating laser wire-filling welding was performed with process parameters: a laser power of 2800 W, a welding speed of 50 mm/s, a defocus of 0 mm, an oscillation frequency of 100 Hz, and an oscillation amplitude of 1.2 mm.
(2) A blue laser (wavelength about 450 nm) was used to bake the solid-state weld seam online. Process parameters of a blue laser power of 500 W and a scanning speed of 60 mm/s were used to bake the weld seam online.
(3) The distance between the oscillating laser beam and the blue laser beam was adjusted and the solidification conditions of the melt pool were controlled to obtain a weld seam with a heterogeneous grain structure of a mixture of fine equiaxed grain zone and coarse grain region; in addition, the defocus of the blue laser was adjusted to bake the weld seam online for 1 min, to promote the composite precipitation of multiple strengthening phases and form a gradient distribution of the multiple strengthening phases along the weld seam depth direction, such that the microhardness also formed a gradient distribution along the weld seam depth direction.

Example 2: this example is a method for obtaining a multi-level heterostructure strengthening structure. The welding base material was a 3 mm thick Al—Mg—Si—Cu alloy sheet with dimensions of 50 mm by 50 mm. The filler material was an Al—Si—Mg—Cu—Zn aluminum alloy welding wire with a diameter of 1.2 mm.

The specific implementation steps of this example were:
(1) Oscillating laser wire-filling welding was performed with process parameters: a laser power of 2800 W, a welding speed of 50 mm/s, a defocus of 0 mm, an oscillation frequency of 100 Hz, and an oscillation amplitude of 1.2 mm.
(2) A blue laser (wavelength about 450 nm) was used to bake the solid-state weld seam online. Process parameters of a blue laser power of 500 W and a scanning speed of 60 mm/s were used to bake the weld seam online.
(3) The distance between the oscillating laser beam and the blue laser beam was adjusted and the solidification conditions of the melt pool were controlled to obtain a weld seam with a heterogeneous grain structure of a mixture of fine equiaxed grain zone and coarse grain region; in addition, the defocus of the blue laser was adjusted to bake the weld seam online for 5 min, to promote the composite precipitation of multiple strengthening phases and form a gradient distribution of the multiple strengthening phases along the weld seam depth direction, such that the microhardness also formed a gradient distribution along the weld seam depth direction.

Comparative Example 1: used for comparison with Example 1. The used material was a 3 mm thick Al—Mg—Si—Cu alloy sheet with dimensions of 50 mm by 50 mm. The filler material was an Al—Si—Mg—Cu—Zn aluminum alloy welding wire with a diameter of 1.2 mm.

This comparative example used direct laser welding:

A laser power of 2800 W, a welding speed of 50 mm/s and a defocus amount of 0 mm were used to perform welding, directly obtaining a welded joint.

By comparison, it can be found that the oscillating laser welding and laser online baking of the weld seam of the present disclosure prepare a structure with a multi-level heterostructure, cooperatively improving the strengthening and plasticity of the heat-treatable strengthened aluminum alloy weld seam.

Above is the description for the technical principle of the present disclosure in combination with detailed embodiments. And these descriptions are only aimed at explaining the principle of the present disclosure, and these descriptions may not be explained in any way to limit the scope of the protection of the present disclosure. Based on the explanations herein, other detailed descriptions of the present disclosure may be achieved by those skilled in the prior art without creative works, and these descriptions are falling into the scope of the protection of the present disclosure.

What is claimed is:

1. A method for cooperatively preparing multi-level heterostructure of weld seam by using dual laser beams, comprising:
step (1): performing filler welding on an aluminum alloy sheet by using an oscillating laser, wherein solidified grains in a melt pool are broken up into broken grains by means of the reheating effect of beam oscillation, to provide nucleation conditions for the formation of a fine equiaxed grain zone;
step (2): repeatedly scanning a weld seam obtained from oscillating laser welding by using a laser, to achieve rapid short-time baking of the weld seam, such that a temperature field generated by baking forms a gradient distribution in a depth direction of the weld seam;
step (3): adjusting process parameters of laser welding and laser baking, to cooperatively control solidification parameters of the melt pool and the temperature field of the weld seam, wherein broken dendrites are retained to form a fine equiaxed grain zone at a bottom of the melt pool, and temperature conditions for nano-phase precipitation are satisfied, to promote precipitation of multiple nano-phases in a gradient distribution in the depth direction of the weld seam, such that the aluminum alloy weld seam comprises heterogeneous grain structure of a mixture of fine equiaxed grain zone and coarse grain region, and a gradient precipitate phase structure, to form a multi-level heterostructure.

2. The method for cooperatively preparing multi-level heterostructure of weld seam by using dual laser beams according to claim 1, wherein the aluminum alloy in step (1) is a heat-treatable strengthened aluminum alloy and is selected from the group consisting of 2XXX series, 4XXX series, 5XXX series, 6XXX series, 7XXX series aluminum alloys and any combination thereof.

3. The method for cooperatively preparing multi-level heterostructure of weld seam by using dual laser beams according to claim 1, wherein a reheating temperature caused by the power, oscillation frequency, and oscillation amplitude of the oscillating laser welding in step (1) is matched with a solidification range of the aluminum alloy sheet.

4. The method for cooperatively preparing multi-level heterostructure of weld seam by using dual laser beams according to claim 1, wherein the oscillating laser filler welding in step (1) is selected from the group consisting of oscillating laser wire-filling welding, oscillating laser powder-filling welding, oscillating laser sheet-filling welding, oscillating laser-CMT hybrid welding, oscillating laser-MIG hybrid welding, oscillating laser-TIG hybrid welding and any combination thereof.

5. The method for cooperatively preparing multi-level heterostructure of weld seam by using dual laser beams according to claim 1, wherein a filler material in step (1) is an Al—Si—Mg—Cu—Zn—Sn series alloy or an Al—Mg—Si—Cu—Zn—Sn series alloy, the form of the filler material is selected from the group consisting of powder of 10 to 200 μm, a thin sheet of 50 to 1000 μm, a welding wire with a diameter of 0.5 to 3.2 mm and any combination thereof.

6. The method for cooperatively preparing multi-level heterostructure of weld seam by using dual laser beams according to claim 1, wherein a laser for baking used in step (2) is selected from the group consisting of an infrared laser, a blue laser, a green laser and any combination thereof.

7. The method for cooperatively preparing multi-level heterostructure of weld seam by using dual laser beams according to claim 1, wherein a temperature for the rapid short-time baking in step (2) is 100 to 350 °C, and a baking time is 0 to 30 min.

8. The method for cooperatively preparing multi-level heterostructure of weld seam by using dual laser beams according to claim 1, wherein the solidification parameters of the melt pool in step (3) comprise temperature gradient, solidification rate, and cooling rate.

9. An apparatus for cooperatively preparing multi-level heterostructure of weld seam by using dual laser beams, comprising a fiber laser with a galvanometer system, a short-band laser, an optical path system, a dual-band hybrid oscillating welding head, a control system, a cooling system, and a protection device, wherein the fiber laser and the short-band laser are installed side by side on an upper portion of the optical path system, the dual-band hybrid oscillating welding head is installed on a lower portion of the optical path system, the control system is in communication connection with the optical path system, the cooling system is installed on the fiber laser and the short-band laser, the protection device is connected to the optical path system.

10. The apparatus for cooperatively preparing multi-level heterostructure of weld seam by using dual laser beams according to claim 9, wherein the cooling system is a cooling water pipe, and the protection device is an inert gas protection pipe.
